(19) United States
(12) Patent Application Publication
(10) Pub. No.: US 2026/0142386 A1
(43) Pub. Date: May 21, 2026

(54) AXIAL INSULATION DISPLACEMENT CONTACT AND CONNECTION ASSEMBLY

(71) Applicants: TE Connectivity Solutions GmbH, Schaffhausen (CH); TE Connectivity Italia Distribution S.r.l., Torino (IT)

(72) Inventors: John MARSH, Schaffhausen (CH); Cretier DANIELE, Torino (IT); Federico LUPO, Torino (IT)

(21) Appl. No.: 19/391,591

(22) Filed: Nov. 17, 2025

(30) Foreign Application Priority Data
Nov. 19, 2024 (IT) 102024000026037

(51) Int. Cl. H01R 4/2466

(52) U.S. Cl. CPC H01R 4/2466

(57) ABSTRACT

An insulation displacement contact includes a plurality of guides placed radially around a receiving axis, the guides for receiving an end of a wire along the receiving axis. The guides include a blade, presenting a cutting edge for cutting, along the receiving axis, an insulator of the wire, as the wire is received; and at least one of a second blade or a spring. A connection assembly includes the insulation displacement contact and a wire.

### CROSS REFERENCE TO RELATED APPLICATIONS

This application claims the benefit of IT Application No. 102024000026037, filed 19-Nov.-2024, the subject matter of which is herein incorporated by reference in its entirety.

### BACKGROUND OF THE INVENTION

Electrical connectors are often designed to contact insulated electrical wires, which have a conductive core and outer insulating layer. Insulation displacement contacts often utilize a contact geometry wherein the electrical connection to the insulated wire is made at 90°, e.g. a blade cuts through the insulation at 90° to the axis of the wire.

High throughput manufacturing can benefit from reduced assembly steps.

### BRIEF DESCRIPTION OF THE INVENTION

In an embodiment, an axial insulation displacement contact (IDC) is disclosed which allows electrical contact to be made, rapidly, to an insulated wire. The axial IDC described herein can speed up manufacturing and/or make manufacturing more efficient, e.g. by reducing assembly steps, and may reduce waste.

In an embodiment, an insulation displacement contact is disclosed that includes a plurality of guides placed radially around a receiving axis, the guides for receiving an end of a wire along the receiving axis. The guides include a blade, presenting a cutting edge for cutting, along the receiving axis, an insulator of the wire, as the wire is received; and at least one of a second blade or a spring. The axial IDC can allow for rapid assembly of the connection assembly, such as without requiring an additional step of stripping the insulation.

In an embodiment, an insulation displacement contact (IDC) is disclosed, including a plurality of guides placed radially around a receiving axis, the guides for receiving an end of a wire along the receiving axis. The guides include a blade, presenting a cutting edge for cutting, along the receiving axis, an insulator of the wire, as the wire is received; and at least one of a rigid opposing feature, second blade, or a spring. The wire can be cut as it is received, which can reduce assembly time and/or increase manufacturing efficiency. The guides can be configured to guide, center, and/or receive the wire along the receiving axis. The at least one second blade or spring can be configured to press the wire toward the blade. The cutting edge can splits the insulation of the wire as the wire is inserted; the cut may expose a radially outer face of the conductor. The blade can make electrical contact to the conductor of the wire.

In an embodiment, a connection assembly is disclosed which includes the IDC and a wire.

The IDC and/or connection assembly can include the following further developments and/or embodiments, which can be combined singly or multiply, independently of each other unless indicated otherwise, for further embodiments. The invention is defined by the claims.

The inward facing surface of the trailing edge of the blade can contact the conductor of the wire. The inward facing surface of the trailing edge of the blade can deform the arrangement of strands within the wire and/or electrically contact a portion of the conductive strands of the wire.

When viewed along a receiving direction (e.g. the direction the wire is moved into the IDC), the cutting edge of the blade can inclined along the receiving direction. The incline can be toward the receiving axis such that a distance, perpendicular to the receiving axis, from the receiving axis to the blade is decreasing along the receiving direction. The cutting edge can extend obliquely with respect to the receiving axis. The cutting edge can be shaped so as to allow cutting of the insulation and make electrical contact with the conductor(s) of the wire by a simple operation of insertion of the wire into the IDC. A gap between the receiving axis and the blade can decrease along the receiving direction. The incline can aid in centering the wire and/or providing appropriate force for cutting and/or deformation of the conductor of the wire.

The blade of the IDC can be configured to plastically deform a surface of a conductor of the wire when the wire has a predetermined gauge; and the wire is a solid wire. Blades configured to deform the conductor can aid in making a robust electrical connection.

The cutting edge of the blade can have a first angle, with respect to the receiving axis, at a distal portion of the blade, and a second angle, with respect to the receiving axis, at a proximal portion of the blade. The first angle is smaller than the second angle. The angles can aid in centering the wire and/or providing appropriate force for cutting and/or deformation of the conductor of the wire, and reducing the risk of long-term damage to the wire. The first angle can be the acute angle at the intersection of a first line that passes along the cutting edge, at the distal portion of the blade, and the receiving axis. The second angle can be the acute angle at the intersection of a second line that passes along the cutting edge, at the proximal portion of the blade, and the receiving axis.

The blade of the IDC can include a following edge which is nearer the receiving axis than the cutting edge. The following edge can be proximal to the cutting edge, e.g. farther along the receiving direction. The following edge geometry can aid in centering the wire and/or providing appropriate force for cutting and/or deformation of the conductor of the wire, and reducing the risk of long-term damage to the wire. The cutting edge can connect two opposite faces of the blade, and the opposite faces can extend radially. The geometry of the opposite faces can aid in centering the wire and/or providing appropriate force for cutting and/or deformation of the conductor of the wire. A reliable electrical connection can be provided by the following edge of the blade, such as a following edge nearer the receiving axis than the cutting edge and/or a following edge that is less sharp than the cutting edge, and/or a following edge that includes a flat surface facing the receiving axis.

The following edge can be proximal to the leading edge and configured for contacting a conductor of an insulated wire; the following edge can connects the opposite faces.

The blade of the IDC can include a transition from the cutting edge to a flat surface which is farther along the receiving direction than the cutting edge. The flat surface can provide a robust electrical connection to the conductor of the wire. The flat surface can face the receiving axis. The flat surface can be at a proximal end of the cutting edge, opposite to the leading edge which is at a distal end. The flat surface can make good electrical contact with the conductor of the inserted wire.

Each guide of the IDC can have a respective closest point to the receiving axis, and the respective closest points of the guides are evenly distributed angularly around the receiving axis. The angles are optionally 180, 120, or 90 degrees. Such a distribution can aid in centering the wire and/or providing appropriate force for cutting and/or deformation of the conductor of the wire.

The blade can include a pair of opposite faces each in a plane parallel to the receiving axis. The cutting edge can connect the opposite faces. The cutting edge can face the receiving axis. The faces can aid in promoting a clean cut of the insulator with a relatively low insertion force. The faces can aid in providing a predictable amount of plastic deformation of the conductor of the wire the while possibly reducing the risk of wire breakage. The blade can have a planar body that extends radially away from the receiving axis, which can aid in centering the wire.

The insulation displacement contact can have a virtual receiving volume, which is bound radially by inward facing surfaces of the guides, extends along the receiving axis. The receiving axis passes through the center of the virtual receiving volume. The bounds of the receiving volume can aid in centering the wire and/or providing an appropriate amount of plastic deformation of the conductor while reducing the risk of wire breakage.

The spring of the IDS is configured to deflect radially away from the receiving axis. The spring can be configured to provide a contact force to the wire toward at least one of the receiving axis or the blade. The spring can aid in centering the wire and/or providing appropriate force for cutting and/or deformation of the conductor of the wire. The spring can present a rounded surface at a distal end thereof. This can aid in guiding and/or centering the wire. A center of curvature of the rounded surface can extend perpendicularly to the receiving direction, e.g. to optimize centering and/or guiding of the wire into the IDC.

The spring can optionally be configured to block the wire and provide increased retention force to prevent unintentional wire extraction. For example, an edge, e.g. a proximal edge, of the spring can function as a barb to inhibit axial removal of the wire from the IDC.

The IDC can include a back plate which is proximal to the blade and can be perpendicular to the receiving axis. The back plate can structurally support the guides and/or limit the insertion of the wire. The back plate and guides can be monolithic, optionally formed from a metal plate. This may enhance structural stability and/or increase manufacturing efficiency.

The IDC can include a housing which includes a hole, along the receiving axis, distal to the guides for receiving the wire; the hole optionally being circular. The housing can aid in protecting the electrical interface between the wire and IDC. The hole can aid in centering the wire.

In an embodiment, a connection assembly is disclosed, including a wire including an insulator and a conductor; and the insulation displacement contact as described in any embodiment herein. An end of the wire can be along the receiving axis; and the blade can be in contact with a surface of the conductor.

The insulator can have a cut, along the receiving axis, at the end of the wire. The surface of the conductor can include a deformation at the end of the wire. The blade can be in contact with the surface of the conductor at the deformation. There can be a proximal flat area of the blade which is in contact with the surface of the wire. The connection assembly can be efficiently assembled. It is possible to assemble the connection by insertion of the wire, e.g. without an previous step of stripping the wire of the insulation.

Herein “and/or” means at least one of the listed elements. For example, “A and/or B” means: only A; only B, at least A; at least B; or at least A and B. For example, “X, Y, and/or Z” means: only X; only Y; only Z; at least X; at least Y; at least Z; only X and Y; only X and Z; only Y and Z; only X, Y, and Z; at least X and Y; at least X and Z; at least Y and Z; or at least X, Y, and Z. A slash, “/” may be used to indicate “and/or.” For example, “a guide guides/receives a wire” can mean that the guide guides and/or receive a wire. Herein an “(s)” at the end of a word means one or more; for example a hole(s) is one or more holes.

In the following, embodiments are described with the aid of figures to aid in understanding. In the figures, elements which correspond to one another in terms of structure and/or function are provided with the same reference signs.

The combinations of features shown and/or described in the individual embodiments are for explanatory purposes only. According to the above explanations, a feature of an embodiment can be omitted if its technical effect is not important for a particular application. Conversely, according to the above explanations, a further feature can be added to an embodiment if its technical effect should be advantageous or necessary for a particular application.

In the following, several examples are described.

### BRIEF DESCRIPTION OF THE DRAWINGS

In the figures:

FIG. 1 shows a contact assembly, according to embodiments,

FIG. 2 shows blades of an IDC, according to embodiments,

FIG. 3 shows, according to embodiments, a cross section of a contact assembly,

FIG. 4 shows, according to embodiments, a schematic of a blade,

FIG. 5 shows, according to embodiments, an IDC,

FIG. 6 shows, according to embodiments, an IDC and a wire,

FIG. 7 shows, according to embodiments, an IDC,

FIG. 8 shows, according to embodiments, an IDC,

FIG. 9 shows, according to embodiments, an IDC,

FIG. 10 shows an IDC, according to an embodiment, and

FIG. 11 shows an IDC, in cross-section, according to an embodiment.

### DETAILED DESCRIPTION OF THE INVENTION

The examples and illustrations described herein are to aid in explanation of various embodiments of the contact assembly, IDC, and components thereof, such as the guides, blade(s), and optional spring(s).

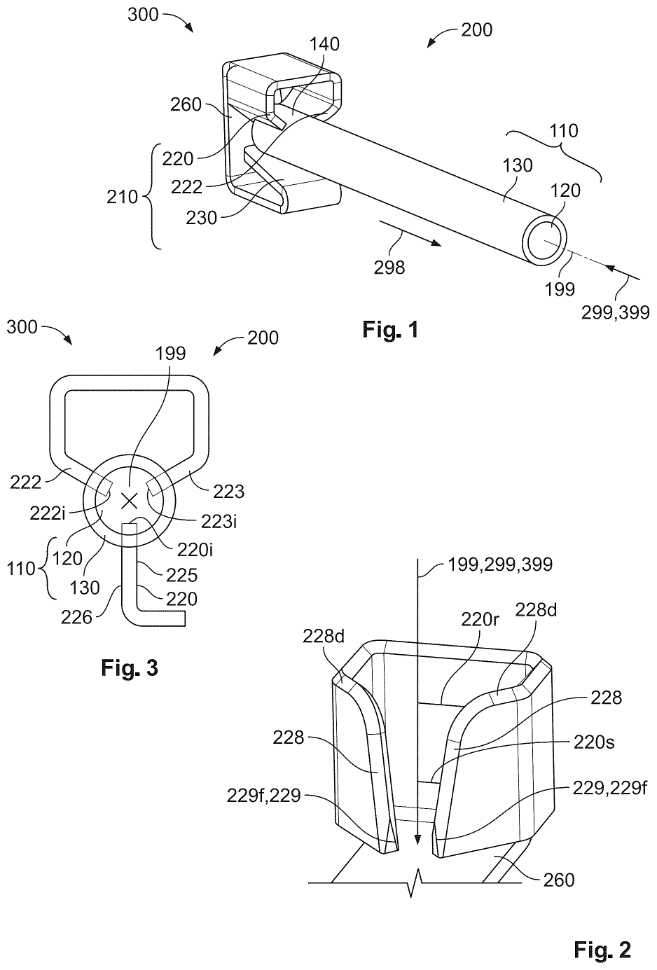

FIG. 1 illustrates, according to an embodiment, a contact assembly. A contact assembly 300 can include an IDC 200, according to any embodiment described herein, and a wire 110.

An IDC 200 can include a plurality of guides 210 placed radially around a receiving axis 199. The guides 210 can be for guiding/receiving an end 140 of a wire 110 along the receiving axis 199. The end 140 of the wire 110 can engage with the IDC 200.

The guides 210 can include a blade 220 and at least one of a second blade 222 or a spring 230. As in the example illustrated in FIG. 1, the guides 210 can include the blade 220, a second blade 222, and a spring 230.

In the contact assembly 300, the wire 110 can be along a receiving axis 199 of the IDC 200. The insulator 120 can include a cut, along the receiving axis 199, at the end 140 of the wire 110. The blade 220 can be in electrical contact with the conductor 120 of the wire 110, e.g. in contact with the surface of the conductor 120. The end 140 of the wire 110 can make contact with the blade 220, e.g. along the longitudinal surface of the wire 110. The conductor 120 may be deformed, such as at the end 140, which may occur when the wire 110 is received by the IDC 200. Deformation may be advantageous, in order to ensure electrical contact between the conductor 120 of the wire 110 and the IDC 200, e.g. the blade(s) 200, 222 thereof. The blade(s) 220, 222 can be in contact with the surface of the conductor 120 at the deformation.

The guides 210 can guide and/or center the wire 110 along the receiving axis 199. The second blade 222 and/or spring 230 can press the wire 110 toward the blade 220, or at least provide a contact force which has a component directed toward the blade 220. The spring 230 can provide a contact force to the wire 110 toward the receiving axis 199 and/or blade 220. The spring 230 can deflect away from the receiving axis 199. The receiving axis 199 can be collinear and/or parallel with the receiving direction 399.

The blade(s) 220 can split the insulation 130 of the wire 110 as the wire 110 is received along the receiving axis 199. The blade(s) 220 can expose a radially outer surface of a conductor 120 of the wire 110 and/or make electrical contact with the conductor 120. It is possible that at least one of the guides 210 deform the conductor 120, e.g. by plastically deforming the outer surface of the conductor 120. This can aid in making robust electrical contact.

FIG. 1 shows a receiving direction 399 which can be the same direction as the proximal direction 299. A wire 110 can be inserted along the receiving axis 199, in the receiving direction 399 (e.g. proximally), toward the IDC 200, to make the contact assembly 300. A distal direction 298 is shown in FIG. 1.

The IDS connector 200 can include a back plate 260. The back plate 260 can be proximal to the guides 210. The back plate 260 can be perpendicular to the receiving axis 199.The back plate 260 can structurally support the guides 210 and/or wire 110 when in contact.

The back plate 260 and guides 210 may be monolithically formed, e.g. made from the same metal material, such as a metal plate precursor. A metal plate may be used to form the back plate 260 and guides 260; e.g. by stamping, cutting, and/or bending. This can simplify manufacturing and/or provide a sturdy IDC 200.

The IDC 200 can allow for rapid assembly of the connection assembly 300, for example, by allowing the electrical connection between the wire 110 and IDC 200 to be made by simple insertion of the wire 110. It may be unnecessary to separately strip the insulation 130 off the wire 110.

FIG. 2 illustrates blades of a IDC, according to embodiments. The blades 220a, 220b described with reference to FIG. 2 can be representative of any one or more blade(s) 220 of any IDC 200 described herein. FIG. 2 shows the receiving direction 399 which can be collinear with the receiving axis 199.

One or more blades 220, 222 of an IDC 200 can have a cutting edge 228 for cutting, along the receiving axis 199, an insulator 130 of the wire 110, as the wire 110 is received. Each blade 220 can have a cutting edge 228. The blade(s) 220 can make electrical contact with the conductor 120 of the wire 110. It is convenient for the cutting and electrical contact to be made as the wire 110 is received into the IDC 200, e.g. to save manufacturing time and/or to reduce manufacturing steps to increase efficiency.

When viewed along the receiving direction 399, the cutting edge 228 of the blade(s) can be inclined along the receiving direction 399. The incline can be, as seen in FIG. 2, toward the receiving axis 199 such that a distance 220r, 220s, perpendicular to the receiving axis 199, from the receiving axis 199 to the blade 220 is decreasing along the receiving direction 399. As seen in FIG. 2, a first distance 220r, which is more distal to the second distance 220s, is greater than the second distance 220s. The cutting edge 228 can extend obliquely with respect to the receiving axis 199. Alternatively/additionally, a gap between the receiving axis 199 and the blade 220 can decrease along the receiving direction 399. There can be a gap between the blades 220, 222.

Alternatively/additionally, a distance between blades 220, 222 can decrease along the receiving direction 399.

The blade 220 can be configured to plastically deform a surface of a conductor 120 of the wire 110.

As in the example illustrated in FIG. 2, the incline of the cutting edge 228 and/or blade 220 can be such that the distance 220r, 220s, perpendicular to the receiving axis 199, from the receiving axis 199 to the blade 220 (e.g. nearest surface of the blade 220), is decreasing along the receiving direction 399. The incline can aid in guiding the wire 110 and/or cutting the insulation 130.

The optional back plate 260 of the IDC 200 may be proximal to the cutting edge 228, trailing edge 229, and/or blade 220. A back plate 260 can simplify manufacture and strengthen the structure. When the back plate 260 and guides 210 are monolithic, such as formed from a single metal plate, the structure can be resistant to stress and/or easy to manufacture.

The receiving axis 199 can be perpendicular to the back plate 260. For example, as in FIG. 3, the receiving axis 199 can be oriented perpendicular to the figure. The receiving axis 199 can be a symmetry axis of the arrangement of guides 210, blades 220, 222, 223, and/or cutting edges 228 thereof. For example, the blades 220, 222, 223 and/or opposite faces 225, 226 thereof, may intersect at the receiving axis 199. Alternatively/additionally, the receiving axis 199 can be at a geometric center of the guides 220 and/or blades 220, 222, 223. The receiving axis 199 can pass through a midpoint between the nearest two surfaces of two of the guides 210, and/or at a point (such as a midpoint) between two guides 210 oriented at 180° radially around the receiving axis 199.

FIG. 3 illustrates, according to an embodiment, a cross-sectional view of a contact assembly. A contact assembly 300 can include an IDC 200 and a wire 110. The guides 210 can include inward facing surfaces 220i, 222i, 223i (e.g. radially inward facing surfaces).

An inward facing surface 220i, 222i, 223i (e.g. radially inward facing surface) of the blade(s) 220, 222, 223 can contact the conductor 120 of the wire 110. Alternatively/additionally, an inward facing surface 220i, 222i, 223i of the blade(s) 220, 222, 223 can deform strands of conductor(s) 120 within the wire 110, e.g. by displacing and/or deforming at least one of the strands of conductors 120 of the wire 110. The receiving axis 199, which is perpendicular to FIG. 3, is depicted as an x.

Herein, an inward facing surface 220i, 222i, 223i can include all or part of the trailing edge 229. An inward facing surface 220i 222i, 223i can include a proximal portion of the cutting edge 228. A distalmost portion 228d of the cutting edge 228 may be oriented to face toward the receiving direction 399, as illustrated in the example of FIG. 2. The distalmost portion 228d of the cutting edge 228 may be positioned to cut the proximal end face 810 of the insulator 130 (e.g. a radially outward portion thereof) when the wire 110 is received/inserted.

For example, the inward facing surface 220i, 222i, 223i of the trailing edge 229 can contact the conductor 120 of the wire 110. Alternatively/additionally, the inward facing surface of the trailing edge 229 can deform the arrangement of strands (e.g. conductors 120) within the wire 110 and/or contact a portion of at least one of the conductors 120 of the wire 110.

Referring to FIG. 2 for illustration, the blade 220 can include a following edge 229. The following edge 229 can be proximal to the cutting edge 228, e.g. immediately proximal thereto. The following edge 229 can be nearer the receiving axis 199 than the cutting edge 228; e.g. the nearest surface of the following edge 229 is nearer to the receiving axis 199 than a nearest surface of the cutting edge 228.

The following edge 229 can contact the conductor 120 when a connection assembly is made, e.g. with a wire 110 in electrical contact with the IDC 200. The cutting edge 228 and/or following edge 229 can deform and/or displace the conductor(s) 120 of a wire 110. For a single solid conductor 120, the cutting edge 228 and/or following edge 229 can deform, e.g. plastically deform the surface of the conductor 120. This can ensure good electrical contact. For a stranded wire 110, with multiple conductors 120, the cutting edge 228 and/or following edge 229 can deform, e.g. plastically deform the surface of the conductor 120. Alternatively/additionally, at least one of the conductors 120 of a stranded wire 110 can be displaced by the cutting edge 228 and/or following edge 229.

The blade 220 and/or guides 210 can have a planar body that may extend radially away from the receiving axis 199.

The cutting edge 228 and/or trailing edge 229 can connect two opposite faces 225, 226 of the blade(s) 220, 222, 223. The opposite faces 225, 226 of any one or more of the blades 220, 222, 223 can extend radially, e.g. radially away from the receiving axis 199. This can aid in guiding the wire 110 into the IDC 200.

Alternatively/additionally, each of the opposite faces 225, 226 can be parallel to the receiving axis 199. Such an orientation can aid in promoting a clean cut when the wire 110 is received and/or aid in guiding the wire 110 along the receiving axis 199. The opposite faces 225, 226 can extend radially, e.g. radially with respect to the receiving axis 199. The opposite faces 225, 226 can, alternatively/additionally, be parallel to each other. Alternatively/additionally, the opposite faces 225, 226 can be parallel to the receiving axis 197.

The receiving axis 199 can be equidistant from at least two guides (e.g. as seen in FIG. 3. for three guides 210 which are the blades 220, 222, 223.

The following edge 229 can be proximal to the leading edge 228. The following edge 229 can be adapted to contact the conductor 120 of the wire 110. The leading edge 228 can be adapted to cut the insulator 130, e.g. an end face 133 of the insulator 130 and/or along the long axis of the insulator 130, e.g. along the receiving direction 199.

The blade 220 can include a transition from the cutting edge 228 to a flat surface 229f. The flat surface 229f can be proximal to the cutting edge 228. The flat surface 229f, which can be at the trailing edge 229, can be farther along the receiving direction 399 than the cutting edge 228. The flat surface 229f can be facing the receiving axis 199, e.g. facing radially inwardly. The flat surface 229f can be at a proximal end of the cutting edge 228. The flat surface 229f can be connected to the leading edge 228 which is at a distal end, e.g. along an edge of the blade 220, 222, 223 that faces the receiving axis 199. The flat surface 229f can be configured to make contact with the conductor of the inserted wire. The flat surface 229f can aid in providing robust electrical contact and/or reduce stress on the wire 110.

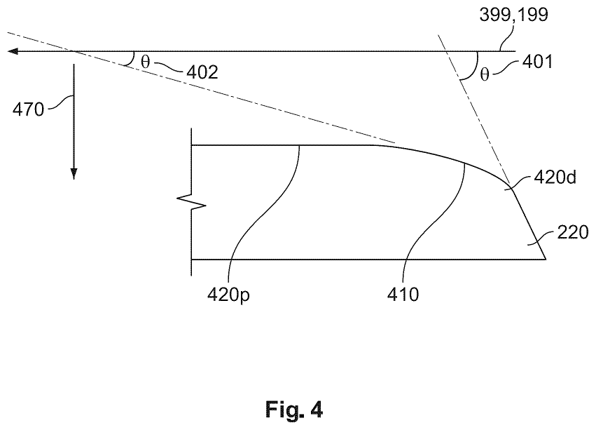

FIG. 4 is a schematic illustration of a blade, according to an embodiment. The schematic shows a blade 220 and edge 410 of the blade 220 that faces the receiving axis 199. The receiving axis 199 can be collinear with the receiving direction 399. A radial direction 470 is shown, e.g. radially away from the receiving axis 199.

The edge 410 of the blade 220 may form a varying angle with respect to the receiving direction 399 and/or receiving axis 199. A first angle 401, of a distal portion 420d of the leading edge 228 of the blade 220, can be greater than a second angle 402, of a proximal portion 420 p of the leading edge 228 and/or proximal portion of the blade 220. The edge 410 can be the leading edge 228.

The first angle and second angles can be the acute angles, rather than an obtuse angle. For example the first angle can be at the intersection of a first line that passes along the cutting edge, at the distal portion of the blade, and the receiving axis. The second angle can be the acute angle at the intersection of a second line that passes along the cutting edge, at the proximal portion of the blade, and the receiving axis.

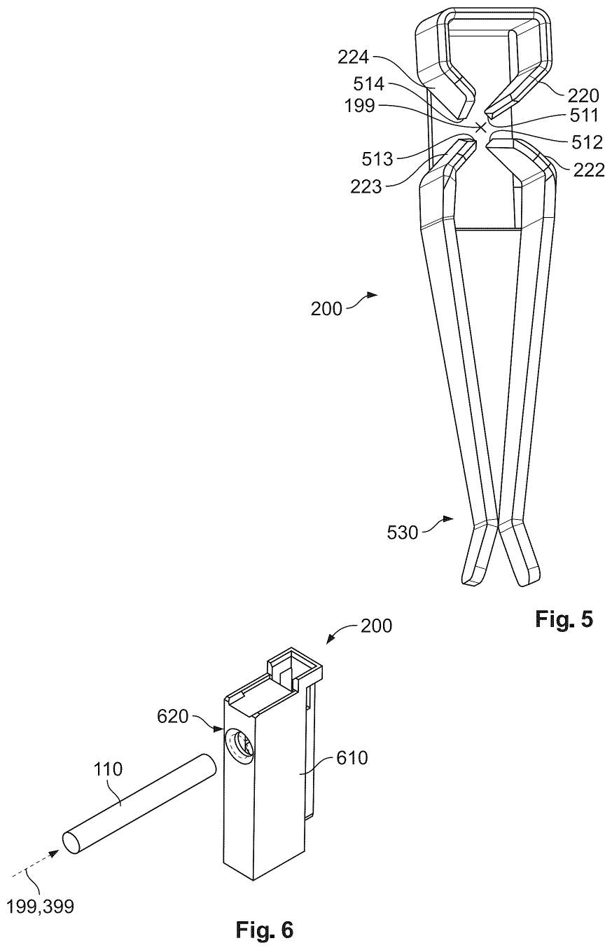

FIG. 5 illustrates a IDC, according to an embodiment. An IDC 200, such as any IDC 200 described herein, can have guides 210 evenly spaced around the receiving axis 199. Alternatively/additionally, each blade 220, 222, 223, 224 and/or guide 210 of the IDC 200 can have a respective closest point 511, 512, 513, 514 to the receiving axis 199. The respective closest points 511, 512, 513, 514 can be evenly distributed angularly around the receiving axis 199. For example, the closest surfaces and/or points 511, 512, 513, 514 of the guides 210 are at 180°, 120°, or 90° around the receiving axis. Evenly spaced guides 210 and/or blades 220, 222, 223, 224 can aid in guiding and/or centering the wire 110. The closest points 511, 512, 513, 514 can be distributed radially around the receiving axis 199. The radial distances from the receiving axis 199 to each of the closest points 511, 512, 513, 514 of blades 220, 222, 223 can be the same. The radial distances from the receiving axis 199 to each of the closest points 511, 512, 513, 514 of springs 230 can be the same; and the distances to optional spring(s) 230 can be smaller compared to the distances to the blades 220, 222, 223.

The blade(s) 220 and/or guides 210 can be configured to cause plastic deformation of the surface of the conductor 120 of a wire 110, of a designated gauge (and/or predetermined gauge), when the wire 110 is received. Alternatively/additionally, the blade(s) 220, 222, 223, 224 can cut into the surface of the conductor 120. The blade(s) 220, 222, 223, 224 can be configured to cut into a designated gauge of wire 110 by a predetermined depth.

Alternatively/additionally, the blade(s) 220 and/or guides 210 can be configured to deform the arrangement of strands of the conductor 120 of a designated gauge of wire 110, e.g. when the wire 110 is formed with strands rather than a single solid conductor core.

For example, the blade(s) 220, 222, 223, 224 can be configured, e.g. by arranging the respective closest point(s) 511, 512, 513, 514 of the blade(s) 220, 222, 223, 224, to cut into a wire 110 by a depth of about 5-10% of the radius of the conductor 120. The radius of the conductor is determinable from the designated wire gauge.

For example, the blade(s) 220, 222, 223, 224 can be configured, e.g. by arranging the respective closest point(s) 511, 512, 513, 514 of the blade(s) 220, 222, 223, 224 to cut into a wire 110 of 4 AWG, having a 21 mm2 cross-sectional conductor area by a depth of 0.13 to 0.26 mm, e.g. about 5-10% of the radius of the conductor 120.

The closest point(s) 511, 512, 513, 514 of the blade(s) 220, 222, 223, 224 can be at the flat surface 229f of the blade(s), or immediately distal thereto.

The closest point(s) 511, 512, 513, 514 of the blade(s) 220, 222, 223, 224 can provide a distance from the receiving axis 199 to the respective closest point(s) 511, 512, 513, 514 which is determined based on the designated wire gauge for which the IDC 200 is intended to be used. For example the provided distance can be from 80% to 99%, 85% to 98%, or 90% to 97% of a conductor radius of a standard wire gauge.

The blade(s) 220, 222, 223, 224 can be configured so that a deformed and/or cut portion of the conductor 120 of the wire 110 abuts the flat surface 229f of the respective blade 220, when the conductor assembly 300 is formed, e.g. when the wire 110 is inserted at least to the proximal end of the blade(s) 220. The IDC 200 can be designed to receive a designated gauge of wire 110, e.g. so that the deformation or cut abuts the flat surface 229f.

The blade(s) 220, 222, 223, 224 can be configured such that, when the wire 110 is inserted, the blade(s) 220, 222, 223, 224 first cut the proximal end face 810 of the insulator 130, e.g. at the proximal end face, such as at a radially outermost portion of the proximal end face 810 of the insulator 130.

The respective closest point(s) 511, 512, 513, 514 of the blades 220 and/or guides 210 can be dimensioned as determined by a standard wire gauge for which the IDC 200 is designed. For example, a designated wire gauge, with which the IDC 200 is designed to connect to form an electrical assembly 300, can determine the respective distances between each of at least two of the closest point(s) 511, 512, 513, 514 and the receiving axis 199, taken along respective radial directions. An IDC 200 can be designed with the respective closest point(s) 511, 512, 513, 514 of the blades 220 and/or guides 210 adapted such that the IDC 200 specifically forms a connector assembly 300 with the designated wire gauge.

For example, the blade(s) 220 and/or guides 210 respective closest point(s) 511, 512, 513, 514 are dimensioned so that when the designated gauge wire is received, the surface of the conductor 120 makes contact with at least one of the blade(s), at least two of the blade(s), or up to all of the blades. The respective closest point(s) 511, 512, 513, 514 can alternatively/additionally be dimensioned so that the surface of the conductor 120 is plastically deformed when the wire 110 of the designated gauge is received.

The radial distance from the receiving axis 199 to the closest point(s) 511, 512, 513, 514 of each blade 220, 221, 222 can be set according to a designated wire gauge (e.g. a standard wire gauge). The radial distance can be smaller than the radius of the designated wire gauge by 1-8%, or by 2-6%, or by 3-5%. Alternatively/additionally, the radial distance from the receiving axis 199 to the flat surface 229f can be smaller than the radius of the designated wire gauge by 1-8%, or by 2-6%, or by 3-5%.

Alternatively/additionally, the second distance 220s, as described herein (see FIG. 2) may be designed to ensure electrical contact between at least one of the blade(s) 220 and the conductor 120 of the wire 110. The second distance 220s may be from the flat surface 229f to the receiving axis 199, e.g. along a radial direction.

An IDC 220 can optionally include a spring clip 530. The spring clip 530 can be used to provide another electrical connection, e.g. in addition to the connection to the wire 110. The spring clip 530 can be part of the same monolithic structure as the back plate 260, guides 210, and/or blade(s) 220, 222, 223, 224.

FIG. 6 illustrates, according to an embodiment, an IDC and wire. FIG. 6 shows an optional housing 610 of an IDC 200 and wire 110. The housing 610 can protect the connection from the environment. The housing 610 can include a hole 620, which can be circular, for receiving the wire 110. The hole 620 can be along the receiving axis 199, and may aid in guiding the wire 110 along the receiving axis 199. The hole 620 can be distal to the guides 210. Receipt of the wire 110 through the hole 620 and electrical contact with the blade(s) 220 can form the contact assembly 300.

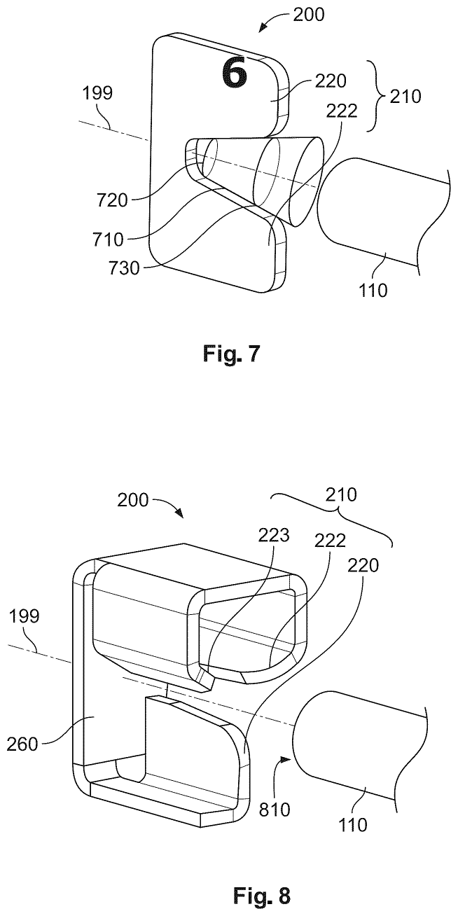

FIG. 7 illustrates, according to an embodiment, an IDC. An IDC 200 can have guides 210 which are two or more blades 220, 222. The receiving axis 199 can be along a symmetry axis of at least two of the two or more guides 210. For two blades 220, 222 that are arranged radially 180° around the receiving axis 199, the receiving axis can be half way between the blades 220, 222.

A virtual receiving volume 710 for the wire 110 can be bounded by the guides 210 and/or blades 220, 222. The volume 710 can extend along the receiving axis 199. The volume 710 can be symmetric about the receiving axis 199. Alternatively/additionally, the volume 710 may be radially bound by the guides 210 and/or blades 220, 222, 223. The volume 710 can be a cone, pyramid, or frustum of a cone or pyramid. The narrow end of the cone or pyramid, which can be truncated, can be proximally located, e.g. near or adjacent the plate 260. The base of the cone or pyramid can be distally located. The volume 710 can become more narrow, radially, along the receiving direction 399. The receiving axis 199 can pass through the center of the virtual receiving volume 710. FIG. 7 shows virtual areas 720, 730, of the virtual receiving volume 710, taken in planes perpendicular to the receiving axis, which become smaller in the proximal direction. A distal area 730 is larger than a proximal area 720. The receiving axis 199 can pass symmetrically through the virtual receiving volume 710, e.g. through the centers of areas 720, 730.

FIG. 8 illustrates, according to an embodiment, an IDC. An IDC 200 can have guides 210 which are three blades 220, 222, 223. The receiving axis 199 can be along a symmetry axis of at least two of the guides 210. For three blades 220, 222, 223, that can be arranged radially 120° around the receiving axis 199, the receiving axis 199 can be a symmetry axis of the arrangement of blades 220, 222, 223.

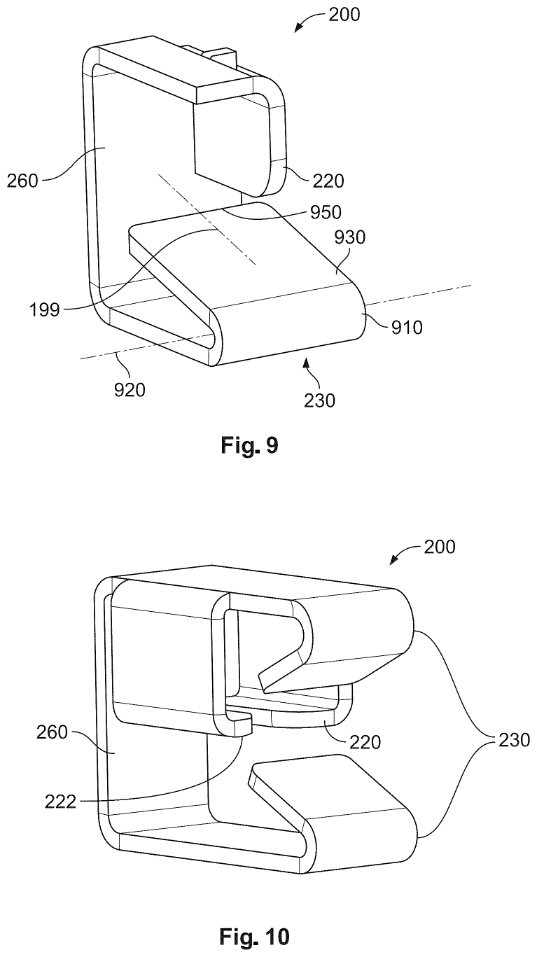

FIG. 9 illustrates, according to an embodiment, an IDS. A spring 230 can provide a contact force on a wire 130, the contact force having a component toward the receiving axis 199. The contact force of the spring 230 on the wire 120 can be directed radially inwardly. The spring 230 can be deflected away from the receiving axis 199 and/or provide a contact force toward the receiving axis 199, e.g. when a wire 130 is received along the receiving axis 199. Alternatively/additionally, the spring 230 can provide a contact force to the wire 110 toward the one or more blades 220, 222, 223.

The spring 230 can present a smooth and/or rounded surface 910 at a distal end. The rounded surface 910 can be formed by a bend in a metal sheet, e.g. a monolithic metal sheet that is used to make the guides 210 and optional back plate 260. The rounded surface 910 can have a center of curvature 920 which extends perpendicularly to the receiving axis 199. The spring 230 can have an incline 930 when viewed along the receiving direction 399. The receiving axis 199 can be along a symmetry axis of the distributions of springs 230 and/or blades 220, 222.

The spring(s) 230 can prevent removal. The proximal end of the spring 230 can have an proximal edge 950 which presses against the wire 110 and may provide a locking force to prevent the wire moving against the receiving direction 399. The proximal edge 950 can be oriented toward the receiving axis 199. The proximal edge 950 can act as a barb and/or be a barb, e.g. to inhibit removal along the axial direction after the wire is in place.

FIG. 10 illustrates an IDC, according to an embodiment. An IDC 200 can have opposing springs 230 and/or opposing blades 220, 222. Opposing springs 230 can be 180° apart, radially distributed around the receiving axis 199. Opposing blades 220, 222 can be 180° apart, radially distributed around the receiving axis 199. The receiving axis 199 can be along a symmetry axis of the distributions of springs 230 and/or blades 220, 222.

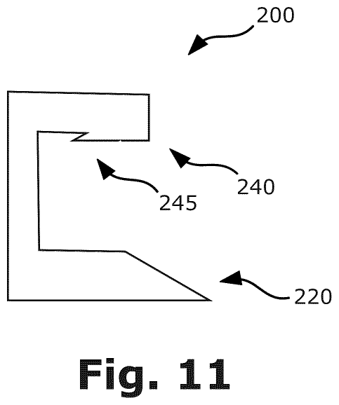

FIG. 11 illustrates an IDC, in cross-section, according to an embodiment. A guide 210 of an IDC 200 can be a rigid opposing feature 240. The rigid opposing feature 240 can impede removal of the wire after insertion. The rigid opposing feature 240 can include a radially inwardly oriented structure, and/or a barb 245 and/or an edge. The barb 245 and/or edge can face the receiving axis and/or the proximal direction. The rigid opposing feature 240 may grip the insulator 130 of the wire 110, after insertion, to impede removal. The insulated wire 110 can be slid over the rigid opposing 240 and/or radially inwardly oriented structure, during insertion.

Alternatively, the rigid opposing feature 240 can be in the hole 620, such as at a periphery of the hole 620, of the housing 610.

The rigid opposing feature 240 can be used singly, multiply, and/or in combination with other guides 210, such as blade(s) 220 and/or spring(s) 230.

Herein “trailing edge” and “following edge” can be used interchangeably. Herein, “leading edge” and “cutting edge” can be used interchangeably.

Herein, the leading edge and/or cutting edge can be distal to the trailing edge and/or following edge. A received wire 110 may first reach the cutting edge 228 of the blade 220 before being further received and reaching the following edge 229.

Herein, proximal can be farther along the receiving direction 399 than distal. For example, a back plate 260 of the IDC 200 may be proximal to the cutting edge and/or trailing edge.

Herein, an IDC may be described with reference to a wire, which may aid in understanding of the structure and/or function of the IDC 200; such descriptions do not imply that the wire 110 is a necessary component of the IDC. As described herein, an IDC 200, according to any embodiment described herein, in combination with a received wire, may form a connection assembly 300 which comprises the wire 110 and IDC 200. The descriptions of embodiments of connection assemblies 300 herein are intended to also describe embodiments of the IDC 200.

Herein, wire gauge may be standard wire gauge, e.g. according to the international standard of the International Electrotechnical Commission (IEC) on conductors of insulated cables, e.g. IEC 60228.

Herein “axis” may be used interchangeably with “receiving axis.” “Receiving axis” may be used interchangeably with “insertion axis.” Herein, a “cutting edge” may have a curve and/or may have a vertex, or pointed edge for cutting, that extends along the curve.

Herein a radial direction can be radial with respect to the receiving axis. Herein the receiving direction and receiving axis can be collinear. The proximal direction can have a component along the receiving direction, e.g. the proximal direction can be parallel to the receiving direction. The distal direction can have a negative dot product with the receiving direction, e.g. be oppositely directed. The proximal direction can have a positive dot product with the receiving direction, e.g. be parallel. The receiving direction can be perpendicular to a back plate of the IDC.

Herein “virtual receiving volume” can be used interchangeably with “volume.”

Herein the components and/or features of the blade 220 described herein can be applied to any one or more of any other blades 220, 222, 223 of the IDC 200. Herein the components and/or features of the spring 230 described herein can be applied to any one or more of any other spring of the IDC 200.

The blades 220, 222, 223 of the IDC 200 described herein can be chamfered to aid in cutting and/or making electrical contact with the conductor of a wire.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An insulation displacement contact comprising:
a plurality of guides placed radially around a receiving axis, the guides for receiving an end of a wire along the receiving axis, wherein
the guides include:
a blade, presenting a cutting edge for cutting, along the receiving axis, an insulator of the wire, as the wire is received; and
at least one of a second blade, a rigid opposing feature, or a spring.

2. The insulation displacement contact of claim 1, wherein:
when viewed along a receiving direction,
the cutting edge of the blade is inclined along the receiving direction.

3. The insulation displacement contact of claim 1, wherein:
the cutting edge of the blade has:
a first angle, with respect to the receiving axis, at a distal portion of the blade, and
a second angle, with respect to the receiving axis, at a proximal portion of the blade; wherein
the first angle is smaller than the second angle.

4. The insulation displacement contact of claim 1, wherein:
the blade includes
a following edge, wherein
the following edge is nearer the receiving axis than the cutting edge.

5. The insulation displacement contact of claim 1, wherein:
the blade includes a transition from the cutting edge to a flat surface; wherein
the flat surface is farther along the receiving direction than the cutting edge.

6. The insulation displacement contact of claim 1, wherein:
each guide has a respective closest point to the receiving axis, and
the respective closest points of the guides are evenly distributed angularly around the receiving axis.

7. The insulation displacement contact of claim 1, wherein:
the blade includes:
a pair of opposite faces each in a plane parallel to the receiving axis, and
the cutting edge connects the opposite faces; wherein optionally
the cutting edge faces the receiving axis.

8. The insulation displacement contact of claim 1, wherein:
a virtual receiving volume, which is bound radially by inward facing surfaces of the guides, extends along the receiving axis; wherein
the receiving axis passes through the center of the virtual receiving volume.

9. The insulation displacement contact of claim 1, wherein:
the spring is configured to deflect radially away from the receiving axis.

10. The insulation displacement contact of claim 1, wherein:
the spring is configured to provide a contact force to the wire toward at least one of the receiving axis or the blade; wherein optionally
the spring includes a proximal edge configured to press against the wire; wherein optionally,
the proximal edge is configured to provide a locking force to prevent the wire moving against the receiving direction.

11. The insulation displacement contact of claim 1, wherein:
the spring presents a rounded surface at a distal end thereof, wherein optionally
a center of curvature of the rounded surface extends perpendicularly to the receiving direction.

12. The insulation displacement contact of claim 1, further comprising:
a back plate which is proximal to the blade and optionally perpendicular to the receiving axis.

13. The insulation displacement contact of claim 12, wherein:
the back plate and guides are monolithic, optionally formed from a metal plate.

14. The insulation displacement contact of claim 1, further comprising:
a housing which includes a hole, along the receiving axis, distal to the guides for receiving the wire; the hole optionally being circular.

15. A connection assembly, comprising:
a wire including an insulator and a conductor; and
an insulation displacement contact including a plurality of guides placed radially around a receiving axis, the guides for receiving an end of the wire along the receiving axis, wherein each of the guides include a blade, presenting a cutting edge for cutting, along the receiving axis, the insulator of the wire, as the wire is received, the insulation displacement contact including at least one of a second blade, a rigid opposing feature, or a spring;
wherein the end of the wire is along the receiving axis and wherein the blade is in contact with a surface of the conductor.

16. The connection assembly of claim 15, wherein:
when viewed along a receiving direction,
the cutting edge of the blade is inclined along the receiving direction.

17. The connection assembly of claim 15, wherein:
the cutting edge of the blade has:
a first angle, with respect to the receiving axis, at a distal portion of the blade, and
a second angle, with respect to the receiving axis, at a proximal portion of the blade; wherein
the first angle is smaller than the second angle.

18. The connection assembly of claim 15, wherein:
the blade includes
a following edge, wherein
the following edge is nearer the receiving axis than the cutting edge.

19. The connection assembly of claim 15, wherein:
the blade includes a transition from the cutting edge to a flat surface; wherein
the flat surface is farther along the receiving direction than the cutting edge.

20. The connection assembly of claim 15,, wherein:
each guide has a respective closest point to the receiving axis, and
the respective closest points of the guides are evenly distributed angularly around the receiving axis.
